(19) United States
(12) Patent Application Publication
(10) Pub. No.: US 2020/0224729 A1
(43) Pub. Date: Jul. 16, 2020

(54) ELASTOMERIC COUPLING

(71) Applicant: ADAM LAWRENCE, Arlington, TX (US)

(72) Inventor: ADAM LAWRENCE, Arlington, TX (US)

(73) Assignee: MARTIN SPROCKET & GEAR, INC., Arlington, TX (US)

(21) Appl. No.: 16/742,271

(22) Filed: Jan. 14, 2020

Related U.S. Application Data
(60) Provisional application No. 62/792,042, filed on Jan. 14, 2019.

(51) Int. Cl. F16D 3/12; F16D 3/74

(52) U.S. Cl. CPC F16D 3/12; F16D 2200/0056; F16D 3/74

(57) ABSTRACT

A coupling for transmitting torque between two shafts has arcuate coupling segments. Each coupling segment has first and second shoes, which are adapted to be operatively attached to the shafts. The first and second shoes each have an inside surface with an inside diameter and an outside surface with an outside diameter. Each coupling segment has elastomer material extending between the first and second shoes. The elastomer material is in contact with portions of the inside surface and the outside surface of each first and second shoe. The elastomer material has a first diameter that is greater than the outside diameter of the first and second shoes and has a second diameter that is less than the inside diameter of the first and second shoes. An arcuate cavity is located inside the elastomer material.

### FIELD OF THE INVENTION

The present invention relates to flexible couplings of the type used to couple two misaligned shafts.

### BACKGROUND OF THE INVENTION

Shaft driven equipment is commonly used in many industries. A typical shaft driven setup includes a drive shaft and a driven shaft. The drive shaft is rotated by a motor, such as electric motor. The driven shaft rotates the load, such as a fan, a sheave for a belt or conveyor, etc.

Ideally, the drive shaft and the driven shaft should be aligned coaxially, with a short gap between the respective ends. This means that the axis of rotation of each shaft is coaxial to the axis of rotation of the other shaft. When the two shafts are properly aligned, a rigid coupling such as a sleeve can be used to span the gap between the two shafts. The coupling transfers the rotation of the drive shaft to the driven shaft, thus driving the load.

However, it is common for the drive shaft and the driven shaft to be misaligned. For example, the axis of rotation of one shaft may be laterally offset from the axis of rotation of the other shaft (parallel or offset misalignment). As another example, the axis of rotation of one shaft may be at a non-zero angle with respect to the other shaft (angular misalignment). The shafts may be misaligned through a combination of offset misalignment and angular misalignment. A rigid coupling cannot be used with misaligned shafts.

Instead, a flexible coupling is used. One type of flexible coupling is an elastomeric coupling. An elastomeric coupling has shoes that couple to the respective shafts. The shoes are connected together by an elastomeric member that spans between the shoes and that is bonded to the shoes. The elastomeric member allows the coupling to be mounted onto and rotate misaligned shafts.

When viewed in axial cross-section, the elastomeric member is bowed in shaped, bulging outwardly in a radial direction. This bulging allows the elastomeric member to better withstand the stresses encountered during operation.

Early couplings clamped the flexible member to the shoes. U.S. Pat. No. 2,648,958 is an example of this style, where the flexible member resembled a tire of sorts. When the flexible member failed, it was replaced by a new flexible member that was clamped to the shoes. As coupling designs progressed, the elastomeric member was bonded to the shoes to create an integral coupling. U.S. Pat. No. 5,611,732 is an example of an integral coupling.

Elastomeric couplings typically have a shorter operational life than rigid couplings. A common point of failure is the area of bonding between the elastomeric member and the shoes. Several designs have been developed to extend the operational life of integral elastomeric couplings. For example, U.S. Pat. No. 5,611,732 notches the axial ends of the metal shoes (the couplings are made in halves to allow installation onto existing shafts). As another example, U.S. Pat. No. 9,249,837 uses extensions of the elastomeric material along the axial ends.

It is desired to improve the operational life of elastomeric couplings by improving the bonding of the elastomeric member to the shoes.

### SUMMARY OF THE INVENTION

A coupling for transmitting torque between two shafts comprises arcuate coupling segments with ends extending generally parallel to a coupling center axis and arcuate portions extending between the ends. The arcuate coupling segments are arranged in a ring with adjacent segments being arranged end to end to form the coupling. Each coupling segment comprises a first shoe adapted to be operatively attached to one of the shafts and a second shoe adapted to be operatively attached to the other shaft. The first and second shoes each have an inside surface with an inside diameter and an outside surface with an outside diameter. Each coupling segment comprises elastomer material extending between a gap formed by the first and second shoes and with the elastomer material being in contact with portions of the inside surface and the outside surface of each first and second shoe. The elastomer material has an outer crossover section with a first diameter that is greater than the outside diameter of the first and second shoes and has an inner crossover section with a second diameter that is less than the inside diameter of the first and second shoes.

In one aspect, the elastomer material further comprises an arcuate cavity located between the first and second crossover sections and extending between the ends.

In another aspect, the arcuate cavity has an axial cross-sectional “oval” shape.

In another aspect, the arcuate cavity has an axial cross-sectional “I” shape. In another aspect, the arcuate cavity has radially extending surfaces and axially extending surfaces, the radially extending surfaces separated from each other by a gap formed by the axially extending surfaces.

In another aspect, the arcuate cavity has radial walls and axial walls, the radial walls being separated from each other by a gap, the gap being smaller than an axial extension of the axial walls.

In another aspect, the cavity has a radial dimension and an axial dimension, the radial dimension being greater than the axial dimension.

In still another aspect, the radial dimension of the cavity is at least 30% greater than the axial dimension.

In still another aspect, the first diameter has a first radial extension from the outside diameter of the first and second shoes and the second diameter has a second radial extension from the inside diameter of the first and second shoes, the first radial extension being larger than the second radial extension.

In still another aspect, the elastomer material has a durometer of Shore A 85-90.

A coupling for transmitting torque between two shafts, comprises arcuate coupling segments with ends extending generally parallel to the coupling center axis and arcuate portions extending between the ends. The arcuate coupling segments are arranged in a ring with adjacent segments being arranged end to end to form the coupling. Each coupling segment comprises a first shoe adapted to be operatively attached to one of the shafts and a second shoe adapted to be operatively attached to the other shaft. The coupling segments each have an inside surface with an inside diameter and an outside surface with an outside diameter. Each coupling segment comprises elastomer material extending between the first and second shoes and in contact with portions of the inside surface and the outside surface of each of the first and second shoes. The elastomer material has an outer portion that extends radially outward from the first shoe, extends axially and extends radially inward to the second shoe and an inner portion that extends radially inward from the first shoe, extends axially and extends radially outward to the second shoe.

In one aspect, the elastomer material further comprises an arcuate cavity located between the inner and outer portions.

In another aspect, the arcuate cavity has an axial cross-sectional “oval” shape.

In another aspect, the arcuate cavity has an axial cross-sectional “I” shape.

In another aspect, the arcuate cavity has radially extending surfaces and axially extending surfaces, the radially extending surfaces separated from each other by a gap formed by the axially extending surfaces.

In another aspect, the arcuate cavity has radial walls and axial walls, the radial walls being separated from each other by a gap, the gap being smaller than an axial extension of the axial walls.

In another aspect, the cavity has a radial dimension and an axial dimension, the radial dimension being greater than the axial dimension.

In still another aspect, the radial dimension of the cavity is at least 30% greater than the axial dimension.

In still another aspect, the outer portion has a first radial extension from the outside diameter of the first and second shoes and the inner portion has a second radial extension from the inside diameter of the first and second shoes, the first radial extension being larger than the second radial extension.

In still another aspect, the elastomer material has a durometer of Shore A 85-90.

### BRIEF DESCRIPTION OF THE DRAWINGS

FIG. 1 is a perspective view of one half of the elastomeric coupling, in accordance with a first embodiment.

FIG. 2 is an end view of the elastomeric coupling of FIG. 1.

FIG. 3 is a cross-sectional view of the coupling, taken through lines 3-3 of FIG. 2.

FIG. 4 is a partial cross-sectional view of the coupling, shown with hubs.

FIG. 5 is a perspective view of one half of the elastomeric coupling, in accordance with a second embodiment.

FIG. 6 is an end view of the elastomeric coupling of FIG. 5.

### DESCRIPTION OF THE PREFERRED EMBODIMENTS

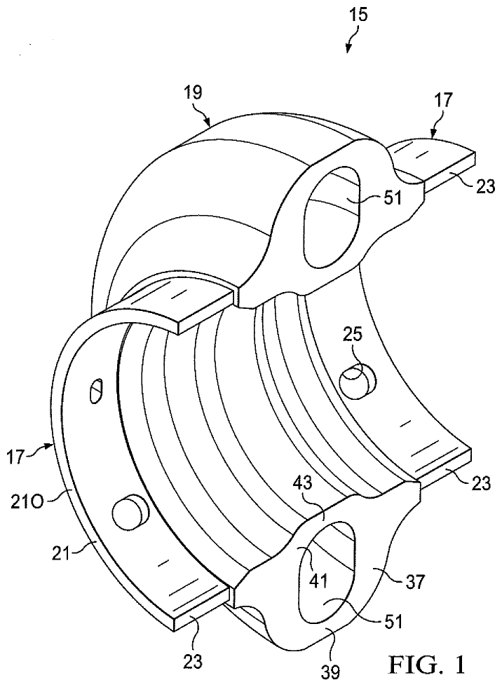

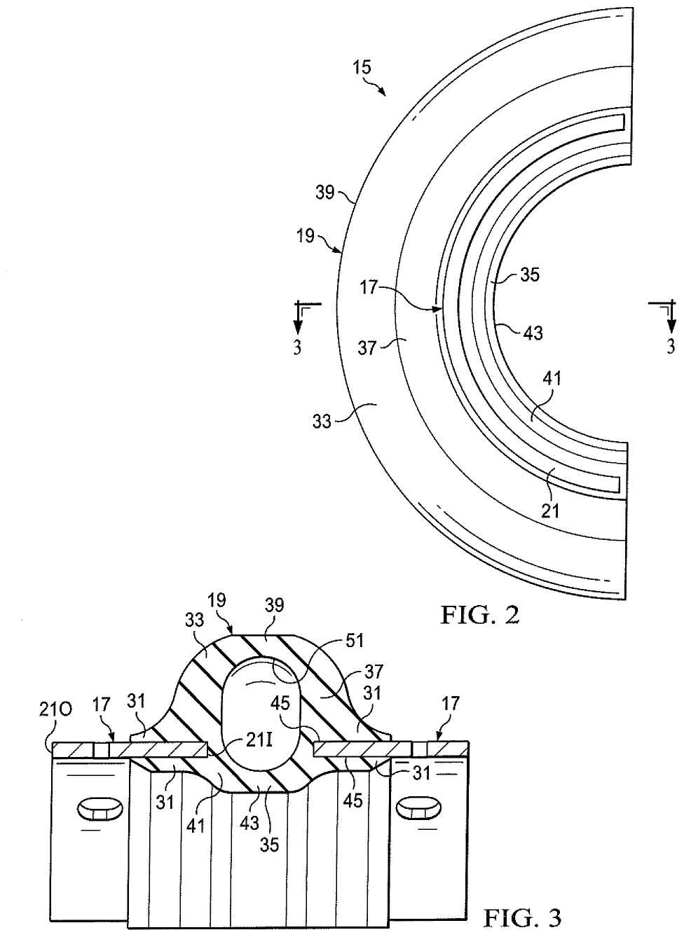

The present invention provides an elastomeric coupling 11 (see FIGS. 1-3) for joining together two shafts. The elastomeric coupling 11 has an elastomeric member 19 that is coupled to shoes 17, which shoes are in turn coupled to hubs, shafts, etc. The elastomeric member 19 is bonded to the shoes 17. The elastomeric member 19 has outer and inner portions that bulge in opposite radial directions from the shoes 17. Thus, the elastomeric member not only bulges radially out, as in prior coupling designs, but also radially in. Surprisingly, providing an inward extension does not interfere with the distribution of stresses in the areas where the elastomeric member bonds to the shoes. Also surprisingly, an inward extension more evenly balances the stresses across the bonding areas and results in prolonged operational life of the coupling. In addition, the coupling is more compact in overall diameter, allowing use in tight spaces. The coupling also minimizes interference with installation onto equipment.

The elastomeric coupling is used to couple together a drive shaft that provides rotary power, and a driven shaft that is rotated and connected to a load. The two shafts are approximately aligned on a central axis. The coupling accommodates some misalignment between the shafts.

In the description herein, reference is made to terms such as “circumferential” and “axial”, which reference the general axis of rotation of the coupling.

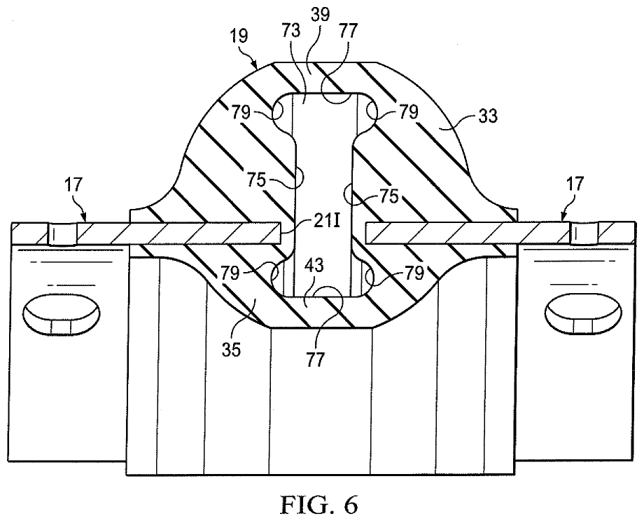

Two embodiments are shown and described. In FIGS. 1-4, a first embodiment is shown. In FIGS. 5-6, a second embodiment is shown. Like reference numbers in the figures designate like components. The shafts of the coupled machinery are not shown for clarity.

Referring to FIGS. 1-4, the coupling 11 has two arcuate coupling segments 15 (FIG. 1 shows one of these coupling segments). Each coupling segment has ends that are generally parallel to the rotational axis. When the arcuate coupling segments are arranged together, so that the respective ends of one segment are adjacent to the ends of the other segment, a ring is effectively formed and the complete coupling encircles the shafts. Providing the coupling in two arcuate segments allows the coupling to be installed onto, and removed from, an existing installation where the shafts are already in place.

Each coupling segment 15 has shoes 17 and an elastomeric member 19.

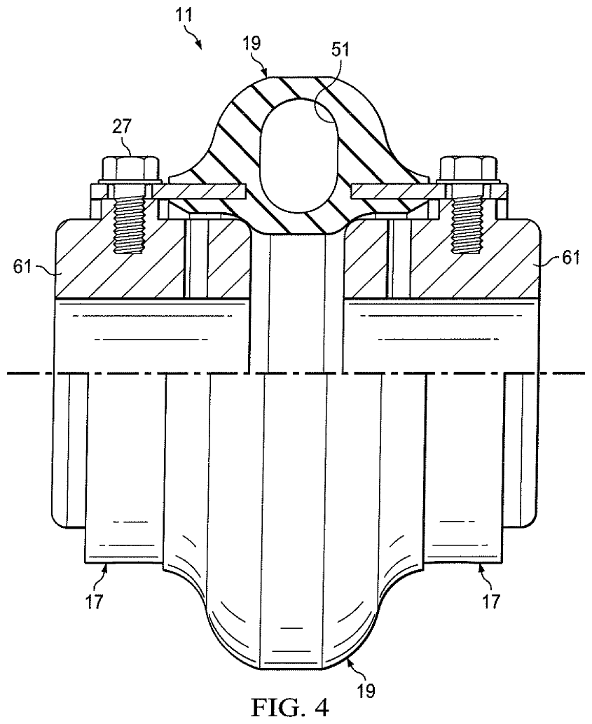

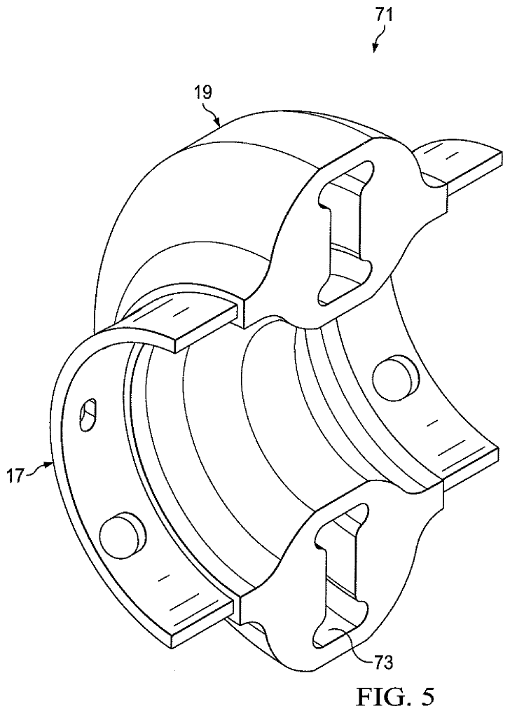

The shoes 17 are operatively attached to the shafts, whether directly or indirectly, by way of hubs. Each shoe 17 is arcuate, having a wall thickness, circumferential ends 21 and axial ends 23. The circumferential ends 21 are arcuate, while the axial ends 23 are straight. As discussed in more detail below, there is an inner circumferential end 211 that contacts the elastomeric member 19, and an outer circumferential end 210 that does not contact the elastomeric member. Each shoe 17 has an inside diameter and an outside diameter. Radial holes 25 are located in each shoe, which holes receive fasteners 27 (see FIG. 4). The shoes in an arcuate coupling segment 15 are spaced apart from one another by a gap. That is to say that there is a gap between the adjacent inner circumferential ends 211. The shoes are aligned along the same axis, with the axial ends 23 being coplanar with respect to each other. The shoes are made of a rigid material, such as steel. In alternate embodiments, the shoes can have radial extending flanges.

The elastomeric member 19 spans between a pair of shoes 17. The elastomeric member 19 has base portions 31 in contact with each shoe 17, an outer portion 33 and an inner portion 35. The outer portion 33 generally extends radially outward from the base portions 31. The inner portion 35 generally extends radially inward from the base portions 31. The base, outer and inner portions 31, 33, 35 are integral.

Each base portion 31 contacts a shoe, namely along the shoe outside diameter, the shoe inside diameter and the shoe inner circumferential end 211. The areas of contact between the base portions 31 and the shoes 17 are bonding areas 45. In the preferred embodiment shown in the drawings, about one half of the shoe 17 outside and inside diameter surface areas are covered by the base portions 31. As shown in FIG. 3, each base portion 31 has a thickness on either side of the shoe 17. The base portion on one shoe is separated from the base portion on the other, adjacent, shoe by a gap.

The outer portion 33 has extension sections 37 that project radially outward from each base portion 31. The extension sections 37 are separated from one another by a gap. A crossover section 39 extends between the outer ends of the extension sections 37. In cross-section as shown in FIG. 3, the outer portion 33 forms a “U” (which is seen as upside down in the orientation of FIG. 3).

The inner portion 35 has extension sections 41 that project radially inward from each base portion 31. A crossover section 43 extends between the outer ends of the extension sections 41.

The outer crossover section 39 has a first diameter and the inner crossover section 43 has a second diameter. In one embodiment, the first diameter is the diameter of the outside surface (the outermost surface) of the outer crossover section 39 and the second diameter is the diameter of the innermost surface of the inner crossover section 43. In this embodiment, the first and second diameters are the outermost and innermost diameters of the crossover sections. In this embodiment, the outer crossover section 39 first diameter is greater than the outside diameter of the shoes 17 and the inner crossover section 43 second diameter is less than, or smaller than, the inside diameter of the shoes 17. In another embodiment, the first diameter is the diameter of the inside surface of the crossover section 39 (the outermost diameter of the passage 51) and the second diameter is the diameter of the innermost surface of the passage at the crossover section 43. In this other embodiment, the first and second diameters are outermost and innermost diameters of the passage at the respective crossover sections. In this other embodiment, the outer crossover section 39 first diameter is greater than the outside diameter of the shoes 17 and the inner crossover section 43 second diameter is less than, or smaller than, the inside diameter of the shoes 17.

The inner portion 35 has a shorter radial extension than that of the outer portion 33. Thus, the outer portion 33 has a first extension in the radial direction, as measured from the shoes. The measurement can be from the outside surface of the shoes. The inner portion 35 has a second extension in the radial direction, as measured from the shoes. This measurement can be from the inside surface of the shoes. The first extension is larger than the second extension. In the preferred embodiment, the outer portion 33 extends 2-3 times more than the inner portion 35, as measured from the respective outside or inside diameter of the shoe.

This difference in radial extensions of the outer and inner portions 33, 35 better balances the stresses applied at the bonding areas between the shoes and the elastomeric member. The stresses are greater closer in radially than further out. Shortening the extension of the inner portion relative to the extension of the outer portion results in the stresses applied by the elastomeric member to be about the same across the bonding areas of the inside diameter and the outside diameter of the respective shoe.

Still another advantage is less interference with hardware, such as hubs or shafts, inserted into the shoes. Due to the lower profile, or shorter extension of the inner portion 35 into the cavity for receiving the shafts, the shafts, etc. can be inserted deeper into the respective shoe.

The elastomeric member 19 has a cavity or passage 51 located between the outer and inner crossover sections 39, 43, the respective extension sections 37, 41 and the base portions 31. The cavity 51 is arcuate in the circumferential direction. In the preferred embodiment, the axial cross-sectional shape of the cavity, as shown in FIG. 3, is shaped. The cavity is larger in the radial dimension than in the axial direction. This shape is referred to herein as “oval”. More specifically, the cavity has radially extending surfaces that are generally parallel to one another and also has generally axially extending surfaces that meet or merge with the radially extending surfaces. The axially extending surfaces are arcuate. The axially extending surfaces form a gap between the radially extending surfaces. The gap is substantially the same size as the axial extension of the axially extending surfaces. In one embodiment, the radial dimension of the cavity is at least 30% larger than the axial dimension. The cavity 51 is open at the axial ends (see FIG. 1).

The cavity 51 and overall configuration of the outer and inner portions 33, 35 allows the each one of the outer and inner portions to flex, bend, twist, etc. somewhat independently of the other. The outer and inner portions are of course joined at the base portions 31. But, the crossover sections 39, 43 are separated from one another by the cavity 51. This separation allows each crossover section to flex and move with little restraint from the other.

The thickness of the extension sections vary. As shown in FIG. 3, the crossover sections 39, 43 are thinner than the extension sections 37, 41. The thickness of the extension sections 37, 41 varies, with the thicker portions located near the base sections and the wall thickness tapering toward the crossover section. In addition, the inner portion extension sections 41 are located closer to each other than that of the outer portion extension sections. This results in a flatter base portion along the inside diameter of the shoes and further reduces the profile or protrusion of the inner portion. Such a reduced profile minimizes interference.

FIGS. 5 and 6 show a second embodiment of a coupling segment 71. The coupling 11 requires two coupling segments 71. While the two embodiments 15, 71 of coupling segments are similar in the elastomeric member 19 having outer and inner portions 33, 35, there are some differences. One difference is the location of the inner circumferential ends 211 of the shoes 17 relative to the cavity. The coupling segment 71 has a cavity or passage 73. The inner circumferential ends 211 extend further into the elastomeric material toward the cavity 73. In other words, for a given size coupling, the gap between the inner circumferential ends 211 is smaller for the coupling segment 71 than for the coupling segment 15. This provides more bonding surface between the shoe and the elastomeric material.

In addition, the axial cross-sectional shape of the cavity or passage 73, is somewhat like an “I”, as shown in FIGS. 5-6. The cavity 73 has a radial extending main portion, and respective outer and inner axial extending end portions. The axial width of each end portion is greater than the axial width of the main portion. Thus, the cavity 73 is defined by parallel radial walls 75 (and their respective radially extending surfaces) along the main portion, and parallel axial walls 77 (and their respective axially extending surfaces) and radiused walls 79 along the end portions. The axial width of the cavity 73 is narrower than the axial width of the cavity 51 in the first embodiment, under constant shoe size and loading characteristics. Thus, as illustrated in FIG. 6, the wall thickness of the elastomeric member is several times thicker along the radial walls 75 than along the axial walls 77. The radiused walls 79 effectively reduce the wall thickness at the “corners” of the cavity, which corners are located at the end portions. The radial walls 75 are separated from each other by a gap, the gap being smaller than the axial extension of the axial walls 77.

The overall effect is to stiffen the elastomeric material near the shoes and provide flexibility at the crossover sections 39, 43. In addition, the response to initial torque loading is improved. When a motor starts and turns the coupling and the load, inertia, from the coupling being at rest, must be overcome. This results in a higher than normal torque load applied to the coupling. The shoe connected to the motor turns, with the shoe connected to the load lagging in time. Eventually, the load shoe will turn at the same speed as the motor shoe and lessen the torque loading, but on start up, the load shoe lags in rotation. This produces some twisting or winding up of the elastomeric member 19. The “I” shaped cavity 73 assists the elastomeric member 19 this initial torque loading.

To manufacture the coupling segment, two shoes are located in a mold. The inside and outside diameters of the shoes, at least where the elastomeric member will contact, have been roughened and coated with an adhesive film of uniform thickness. The mold is closed and an arcuate mandrel extends into the mold cavity to form the cavity 51. The mandrel may be in two pieces, with each mandrel piece extending into the mold from each axial end 23 and meeting the opposite mandrel piece. Thus, each mandrel piece extends for approximately one fourth of the overall circumference of the coupling cavity (or one half of the cavity of the coupling segment). Polyurethane is then added to the mold cavity and allowed to cure. Once cured, the mandrel is retracted and the mold opened to allow removal of the coupling, which now has the elastomeric member bonded to the shoes.

The elastomeric member is, in the preferred embodiment, made of polyurethane. The durometer is Shore A 70-90, and preferably Shore A 85-90.

The installation of the coupling will now be discussed. Couplings are available in different sizes. Various factors are used to determine the proper sized coupling. Such factors include horsepower and rpms of the motor and the load (such as torque). For a given size coupling, the overall diameter of the coupling 11 of the present invention is smaller than prior art couplings. In some installations, the amount of available room is too small to use a properly sized coupling. In the past, this has meant a coupling sized too small for the job has been used. With the coupling of the present invention, a properly sized coupling can be used in tight or confined spaces.

Typical installations provide hubs 61 (see FIG. 4) on the shafts (not shown). The hubs are located onto the shafts, one hub per shaft. The shoes are then aligned with the hubs to set the axial locations of the hubs and the hubs are secured in place, such as by tightening set screws. The shoes are then secured to the hubs by the fasteners 27. Replacement of the coupling involves removal of the old coupling and installing the new coupling.

The coupling distributes stresses over larger bonding areas 45 and more evenly across those bonding areas, resulting in a longer operational life.

The foregoing disclosure and showings made in the drawings are merely illustrative of the principles of this invention and are not to be interpreted in a limiting sense.

1. A coupling for transmitting torque between two shafts, comprising:
a) arcuate coupling segments with ends extending generally parallel to a coupling center axis and arcuate portions extending between the ends, the arcuate coupling segments being arranged in a ring with adjacent segments being arranged end to end to form the coupling, each coupling segment comprising a first shoe adapted to be operatively attached to one of the shafts and a second shoe adapted to be operatively attached to the other shaft, the first and second shoes each having an inside surface with an inside diameter and an outside surface with an outside diameter; and
b) each coupling segment comprising elastomer material extending between a gap formed by the first and second shoes and with the elastomer material being in contact with portions of the inside surface and the outside surface of each first and second shoe, the elastomer material having an outer crossover section with a first diameter that is greater than the outside diameter of the first and second shoes and having an inner crossover section with a second diameter that is less than the inside diameter of the first and second shoes.

2. The coupling of claim 1 wherein the elastomer material further comprises an arcuate cavity located between the first and second crossover sections and extending between the ends.

3. The coupling of claim 2 wherein the arcuate cavity has an axial cross-sectional “oval” shape.

4. The coupling of claim 2 wherein the arcuate cavity has an axial cross-sectional “I” shape.

5. The coupling of claim 2 wherein the arcuate cavity has radially extending surfaces and axially extending surfaces, the radially extending surfaces separated from each other by a gap formed by the axially extending surfaces.

6. The coupling of claim 2 wherein the arcuate cavity has radial walls and axial walls, the radial walls being separated from each other by a gap, the gap being smaller than an axial extension of the axial walls.

7. The coupling of claim 2 wherein the cavity has a radial dimension and an axial dimension, the radial dimension being greater than the axial dimension.

8. The coupling of claim 7 wherein the radial dimension of the cavity is at least 30% greater than the axial dimension.

9. The coupling of claim 1 wherein the first diameter has a first radial extension from the outside diameter of the first and second shoes and the second diameter has a second radial extension from the inside diameter of the first and second shoes, the first radial extension being larger than the second radial extension.

10. The coupling of claim 1 wherein the elastomer material has a durometer of Shore A 85-90.

11. A coupling for transmitting torque between two shafts, comprising:
a) arcuate coupling segments with ends extending generally parallel to the coupling center axis and arcuate portions extending between the ends, the arcuate coupling segments being arranged in a ring with adjacent segments being arranged end to end to form the coupling, each coupling segment comprising a first shoe adapted to be operatively attached to one of the shafts and a second shoe adapted to be operatively attached to the other shaft, the coupling segments each having an inside surface with an inside diameter and an outside surface with an outside diameter; and
b) each coupling segment comprising elastomer material extending between the first and second shoes and in contact with portions of the inside surface and the outside surface of each of the first and second shoes, the elastomer material having an outer portion that extends radially outward from the first shoe, extends axially and extends radially inward to the second shoe and an inner portion that extends radially inward from the first shoe, extends axially and extends radially outward to the second shoe.

12. The coupling of claim 11 wherein the elastomer material further comprises an arcuate cavity located between the inner and outer portions.

13. The coupling of claim 12 wherein the arcuate cavity has an axial cross-sectional “oval” shape.

14. The coupling of claim 12 wherein the arcuate cavity has an axial cross-sectional “I” shape.

15. The coupling of claim 12 wherein the arcuate cavity has radially extending surfaces and axially extending surfaces, the radially extending surfaces separated from each other by a gap formed by the axially extending surfaces.

16. The coupling of claim 12 wherein the arcuate cavity has radial walls and axial walls, the radial walls being separated from each other by a gap, the gap being smaller than an axial extension of the axial walls.

17. The coupling of claim 12 wherein the cavity has a radial dimension and an axial dimension, the radial dimension being greater than the axial dimension.

18. The coupling of claim 17 wherein the radial dimension of the cavity is at least 30% greater than the axial dimension.

19. The coupling of claim 11 wherein the outer portion has a first radial extension from the outside diameter of the first and second shoes and the inner portion has a second radial extension from the inside diameter of the first and second shoes, the first radial extension being larger than the second radial extension.

20. The coupling of claim 11 wherein the elastomer material has a durometer of Shore A 85-90.
